(19) United States
(12) Patent Application Publication
(10) Pub. No.: US 2015/0230662 A1
(43) Pub. Date: Aug. 20, 2015

(54) Microwave-Heatable Thermal Storage Pad and a Food Heating Kit Having the Same

(71) Applicant: That Inventions Co., Taipei City (TW)

(72) Inventors: Jung-Ya Hsieh, Jhubei City (TW); Yung-Fu Lin, Jhubei City (TW)

(21) Appl. No.: 14/622,290

(22) Filed: Feb. 13, 2015

(30) Foreign Application Priority Data
Feb. 19, 2014 (TW) 103105558
Jan. 16, 2015 (TW) 104101477

(51) Int. Cl. A47J 39/02; A47J 36/02; H05B 6/80

(52) U.S. Cl. CPC A47J 39/02; H05B 6/80; A47J 36/02

(57) ABSTRACT

A microwave-heatable thermal storage pad includes a main body and at least one thermal storage medium. The main body has at least one projecting portion and a holding flange extending outwardly from a peripheral edge of a bottom of the projecting portion. The projecting portion has an enclosing wall of low thermal conductivity, wherein the enclosing wall defines a recessed space. The thermal storage medium, being located in the recessed space, has an exposed top surface which is exposed to a top opening of the recessed space of the main body, and has a periphery which is at least partially surrounded by the enclosing wall of the projecting portion. The thermal energy stored in the thermal storage medium will be exchanged with the outside substantially through the exposed top surface thereof.

### RELATED APPLICATION

This application claims the benefit of Taiwanese patent application 103105558, filed on Feb. 19, 2014, and Taiwanese patent application 104101477, filed on Jan. 16, 2015, the specifications of which are incorporated herein by reference.

### FIELD OF THE INVENTION

The present invention relates to a microwave-heatable thermal storage pad and a food heating kit having the same, which allows a food in a container to maintain a warm temperature suitable for the eating habits of consumers, and can protect the consumers from being scalded or burnt.

### BACKGROUND OF THE INVENTION

In today's eating habits, people would like to have warm foods rather than overly cold foods. However, busy work often keeps a person from enjoying warm food immediately after it has been cooked. The cooked food is usually laid aside for a period of time. When the person is at leisure, the cool food is heated again. Since several beverages, such as coffee, Japanese rice wine, tea and so on, have different tastes at different temperatures, they will lose pleasant flavors when they are cool. Thus, various heating or insulating devices for foods have been produced to meet the demand of heating or insulating foods and beverages.

For rapidly heating foods, most of existing heating devices are formed of metals with high thermal conductivity. Although metallic heaters allow foods to be heated rapidly, they can easily cause scalds to users. Thus, when the metallic heaters are at high temperature, users should wait until the temperatures of the heaters drop slightly so that the users can touch them without being burnt, or the users should wrap an insulating cloth around the metallic heaters to keep them from directly contacting their hands. Thus, the operation of the metallic heaters is inconvenient.

Furthermore, although metal can heat foods rapidly, it can dissipate heat rapidly as well. Thus, the existing heaters are poor in the preservation of heat. For maintaining the foods at desired temperatures, the heaters should continually consume electrical power or gas to supply heat to the foods, and this is inconvenient. Usually, as soon as a food has been heated in a heater, the heater together with the food is required to be moved to another location, for example, being moved from a kitchen to a table. In this situation, if the heater made of metal, it is inconvenient for a user to move it. Since a metallic heater has a good thermal conductivity, if no heat is supplied from electrical power or gas, the temperature of the heater as well as the food contained therein will drop rapidly, so that the food will lose the flavors that are existed in the hot condition. Furthermore, some beverages are not suitable to be directly heated, for example, Japanese rice wine and some dairy products may lose the pleasant flavors when they are heated in microwave ovens. On the other hand, if they are indirectly heated by water, the process is time-consuming.

Particularly, when liquid food is heated in the container of an existing heater, a user often employs a tray under the container to avoid direct contact with the container. Due to the contact between the container and the tray being not tight, during a movement of the container with the tray, the liquid food may spill over the container, thus causing scalding to the user.

In view of the foregoing, there is a need to develop a thermal storage pad that can supply stable heat for a long time and a food heating kit that can reduce heat loss from a container thereof, so that a food can maintain a desired temperature for a longer time. Furthermore, the container can be securely placed on the thermal storage pad. Thus, during a movement, the container is not easy to shift or even fall away, so that the food in the container can retain heat and the user can be protected from being scalded or burnt.

### SUMMARY OF THE INVENTION

One object of the present invention is to provide a microwave-heatable thermal storage pad that has an adequate heat capacity and can supply heat for a long time.

Another object of the present invention is to provide a microwave-heatable thermal storage pad that has a holding flange of low thermal conductivity to facilitate a user to take the thermal storage pad.

A further object of the present invention is to provide a microwave-heatable thermal storage pad that has an enclosing wall of low thermal conductivity to prevent a user from being burnt when touching it, so as to increase the safety of using the pad.

A still further object of the present invention is to provide a food heating kit with a microwave-heatable thermal storage pad, wherein a container thereof can be sit on the thermal storage pad properly to prevent the container from shifting or even falling away during a movement, so as to reduce the possibility of a user being scalded or burnt.

To achieve the above objects, the microwave-heatable thermal storage pad may comprise a main body and at least one thermal storage medium. The main body has at least one projecting portion and a holding flange extending outwardly from a peripheral edge of a bottom of the projecting portion. The projecting portion has an enclosing wall of low thermal conductivity, wherein the enclosing wall defines a recessed space that includes a top opening. The thermal storage medium, being located in the recessed space, has an exposed top surface which is exposed to the top opening of the recessed space of the main body, and has a periphery which is at least partially surrounded by the enclosing wall of the projecting portion. Furthermore, the thermal storage medium has a thermal conductivity greater than the enclosing wall of the projecting portion, whereby the thermal energy stored in the thermal storage medium will be exchanged with the outside substantially through the exposed top surface thereof.

The food heating kit may comprise a microwave-heatable thermal storage pad and a container, wherein the microwave-heatable thermal storage pad includes a main body and at least one thermal storage medium; the container includes a container shell, an engagement wall, and an enclosing wall. The main body has at least one projecting portion and a holding flange extending outwardly from a peripheral edge of a bottom of the projecting portion. The projecting portion has an enclosing wall of low thermal conductivity, wherein the enclosing wall defines a recessed space that includes a top opening. The thermal storage medium, being located in the recessed space, has an exposed top surface which is exposed to the top opening of the recessed space of the main body, and has a periphery which is at least partially surrounded by the enclosing wall of the projecting portion. Furthermore, the thermal storage medium has a thermal conductivity greater than the enclosing wall of the projecting portion, whereby the thermal energy stored in the thermal storage medium will be exchanged with the outside substantially through the exposed top surface thereof. The container shell has a bottom being provided with a thermal contact area. The engagement wall extends downwardly from the bottom of the container shell. The enclosing wall of the container extends upwardly from the bottom of the container shell to define a receiving space that includes a top opening.

Accordingly, in the microwave-heatable thermal storage pad and the food heating kit with the microwave-heatable thermal storage pad of the present invention, the thermal storage pad is heated by using microwave energy instead of electrical power commonly seen in the existing technology, and then can be carried by users for heating foods. Particularly, the thermal storage pad employs a main body to fix a thermal storage medium in place, wherein the main body has a thermal conductivity lower than the thermal storage medium, so that unnecessary heat loss of the thermal storage pad can be reduced and thus the heating time that the pad can provide is prolonged and the heat stored in the thermal storage medium can be stably transferred to an object to be heated. Furthermore, the main body is provided with a holding flange, which can facilitate users to take the thermal storage pad by hands. Furthermore, since the thermal storage medium is surrounded by the enclosing wall of the projecting portion having a low thermal conductivity, the users can be protected from being burnt when touching the pad, so that the safety of using the pad can be increased. Furthermore, in using the food heating kit, since a container thereof can securely sit on the associated thermal storage pad, the container is uneasy to shift or fall off the pad, thus increasing the safety of using the kit.

### BRIEF DESCRIPTION OF THE DRAWINGS

The foregoing and other features and advantages of illustrated embodiments of the present invention will be more readily apparent from the following detailed description, which proceeds with reference to the accompanying drawings.

FIG. 1 shows a sectional view of a main body used in a thermal storage pad according to a first exemplary embodiment of the present invention.

FIG. 2 shows a sectional view of a thermal storage medium used in the thermal storage pad of the first exemplary embodiment of the present invention.

FIG. 3 shows a sectional view of the thermal storage pad of the first exemplary embodiment of the present invention, wherein the thermal storage medium is fitted into the main body.

FIG. 4 shows a sectional view of a Japanese-wine bottle used in a food heating kit according to a second exemplary embodiment of the present invention.

FIG. 5 shows an exploded sectional view of the food heating kit of the second exemplary embodiment of the present invention, wherein the Japanese-wine bottle can be securely placed on the thermal storage pad.

FIG. 6 shows a sectional view of the thermal storage medium of the present invention, wherein the thermal storage medium is shaped to have a top projection and a bottom recess corresponding to the top projection.

FIG. 7 shows an exploded view of a thermal storage pad according to a third exemplary embodiment of the present invention, wherein the thermal storage pad includes a wireless charging module.

### DETAILED DESCRIPTION OF THE ILLUSTRATED EMBODIMENTS

The foregoing and other technical contents, features and advantages of the present invention will be illustrated in detail by way of exemplary embodiments with reference to the accompanying drawings. In the exemplary embodiments, same elements will be indicated by similar numerals or labels.

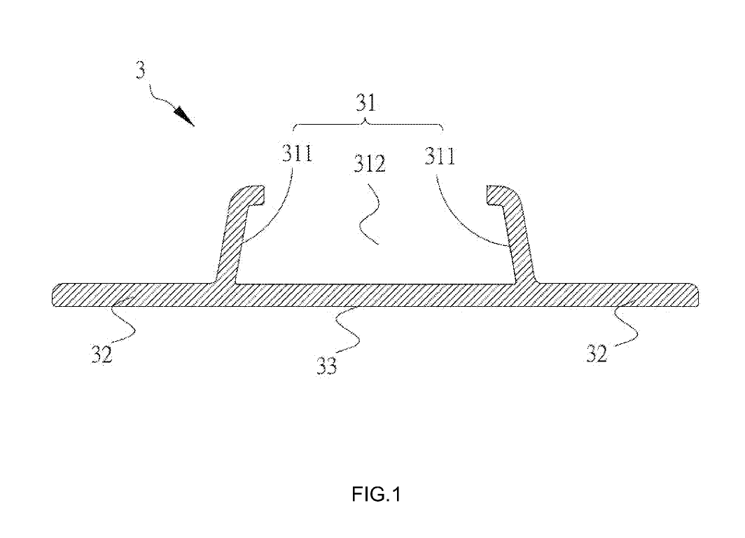

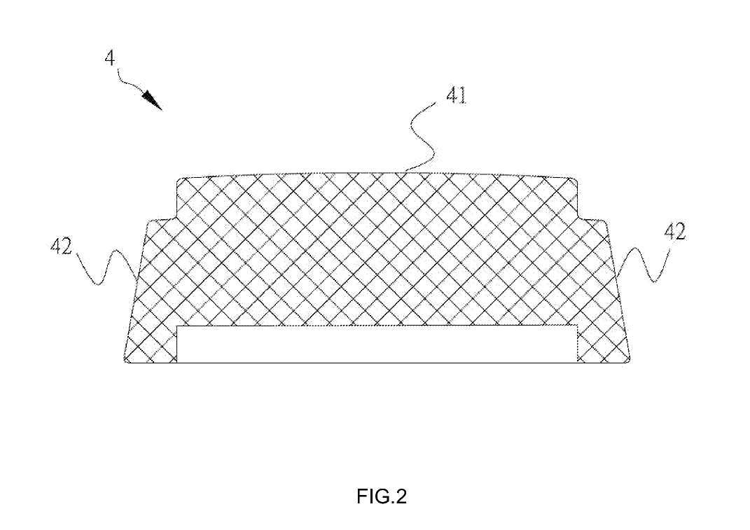

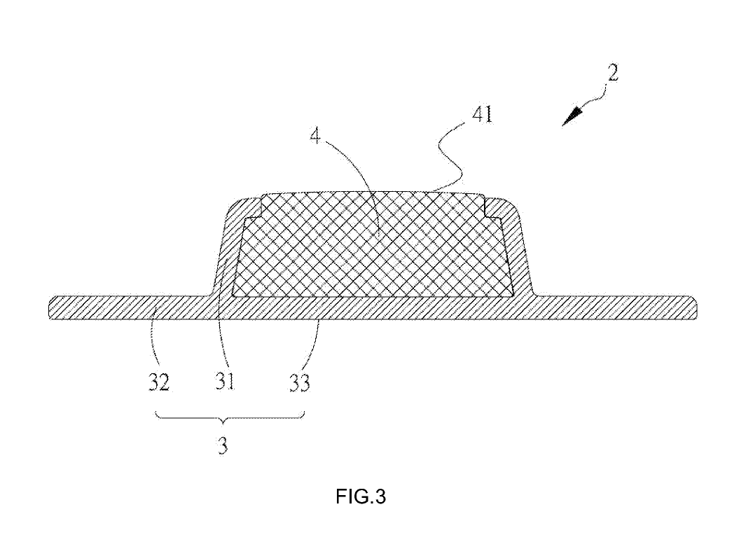

Referring to FIGS. 1 through 3, a first exemplary embodiment of the present invention shows a microwave-heatable thermal storage pad 2, which includes a main body 3 and a thermal storage medium 4 fitted into the main body 3. The thermal storage medium 4 is formed of polar substance, so that it can absorb microwave. More specifically, the thermal storage medium 4 is a sintered ceramic body containing powders of triiron tetraoxide (Fe3O4). Although the thermal storage medium 4 has a specific heat less than water, it has a specific weight greater than water; therefore, the thermal storage medium 4 can store more thermal energy than water per unit of volume. Although this embodiment employs the sintered ceramic body containing triiron tetraoxide powders as a thermal storage medium, those skilled in the art may know that the thermal storage medium 4 can be formed of other material containing polar substances, such as silicone carbide (SiC) and diiron trioxide (Fe2O3), without affecting an implementation of the embodiment. As to the main body 3, it can be formed of silicone material.

The main body 3 has a projecting portion 31 and a holding flange 32 extending outwardly from a peripheral edge of a bottom of the projecting portion 31. A user can take the holding flange 32, which is made of silicone material and has a lower thermal conductivity than the thermal storage medium 4, to place the thermal storage pad 2 into a microwave oven. Since the thermal conductivity of silicone material is not good, a user can directly take the holding flange 32 by a hand without being scalded or burnt. Thus, when a user takes, moves, or carries the thermal storage pad 2, an insulating tool is not required, so that the thermal storage pad 2 can be used more conveniently.

The projecting portion 31 of the main body 3 has an enclosing wall 311 of low thermal conductivity, which facilitate the heat stored in the thermal storage medium 4 to be transferred upwardly, thereby preventing the heat from being transferred along other random directions. Furthermore, the enclosing wall 311 defines a recessed space 312 that includes a top opening, wherein the recessed space 312 allows the sintered thermal storage medium 4 to be properly accommodated. The thermal storage medium 4 has an exposed top surface 41 and a periphery 42 being partially surrounded by the enclosing wall 311 that has a thermal conductivity lower than the periphery 42 of the thermal storage medium 4. Heat exchange is substantially achieved through the exposed top surface 41 of the thermal storage medium 4, which is exposed to the top opening of the recessed space 312 of the main body 3, so that the heat stored in the thermal storage medium 4 can be prevented from unnecessary loss. As such, when the thermal storage pad 2, after having been heated in a microwave oven, is taken out to a courtyard or an outside field, the time period during which the thermal storage pad 2 keeps adequate heat can be prolonged.

Furthermore, the main body 3 has a non-slip bottom surface 33 opposite to the exposed top surface 41 of the thermal storage medium 4. By roughening an outer surface of the bottom of the silicone-made projecting portion 31, the friction coefficient of the outer surface of the bottom can be increased, so that the bottom surface 33 can provide a non-slip function. Therefore, when the thermal storage pad 2 is placed on a desk or a tray for moving to a different location, the non-slip bottom 33 can prevent the thermal storage pad 2 from substantial unwanted shift or hitting other objects and thus falling away.

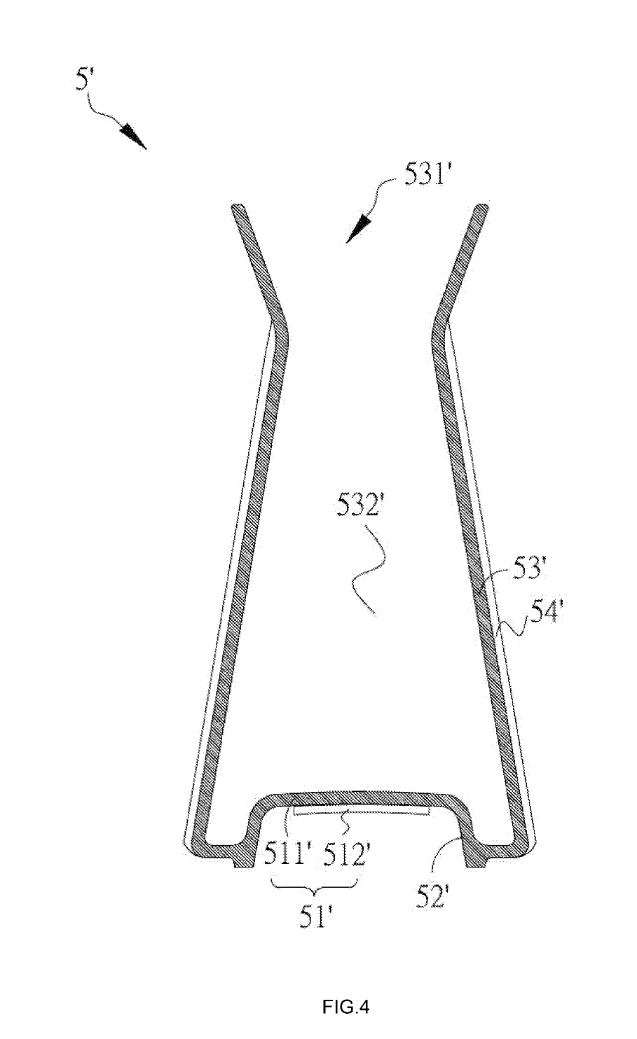

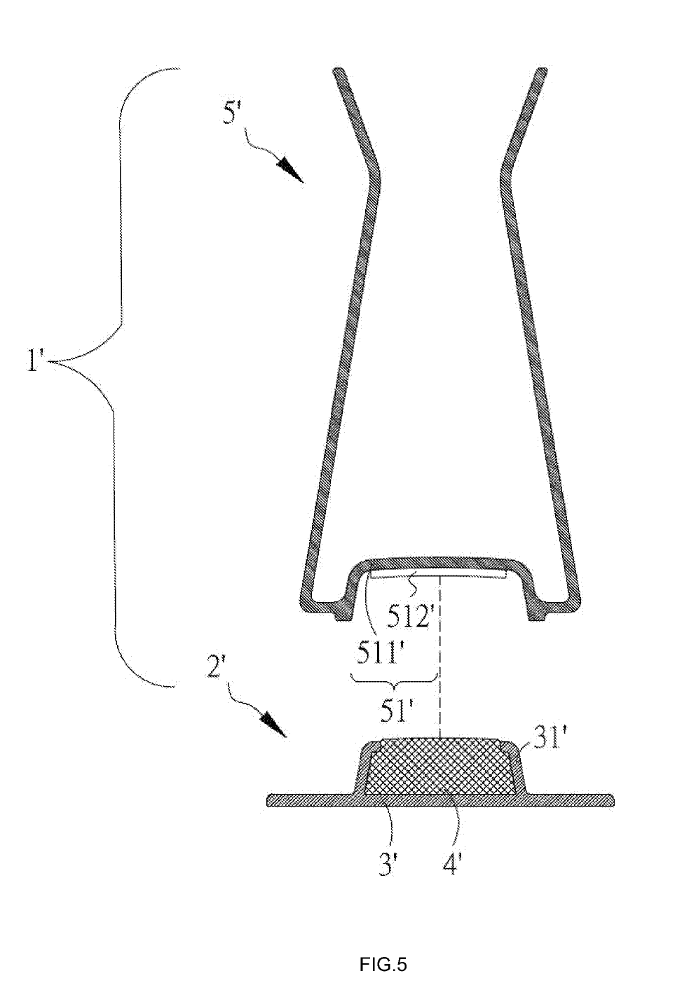

Referring to FIGS. 4 and 5, a second exemplary embodiment of the present invention shows a food heating kit 1′, which generally comprises a thermal storage pad 2′ and a container 5′, wherein the thermal storage pad 2′ is same as the one illustrated in the first exemplary embodiment. In this embodiment, the container 5′ is shown by a Japanese-wine bottle of substantially cylindrical shape, which is typically for storing a Japanese rice wine, known as “sake”. More specifically, the Japanese-wine bottle 5′ is a sintered ceramic body, the material of which is similar to the thermal storage medium 4′. In this embodiment, the bottle 5′ has a container shell 51′ with a bottom 511′, an enclosing wall 53′ extending upwardly from the bottom 511′ of the container shell 51′, and an insulating layer 54′ on an outer surface of the enclosing wall 53′, wherein the insulating layer 54′ has a thermal conductivity lower than the thermal storage medium 4′.

The enclosing wall 53′ defines a receiving space 532′ that includes a top opening 531′ for storing a Japanese rice wine or other beverages required to be heated. Furthermore, the container shell 51′ is provided with an engagement wall 52′ extending downwardly from the bottom 511′ of the container shell 51′, which allows the bottle 5′ to sit on the projecting portion 31′ of the main body 3′ properly. To ensure a close contact between the bottom 511′ of the Japanese-wine bottle 5′ and the thermal storage medium 4′, the thermal storage medium 4′ is preferably provided with a flexible thermal conductive layer (not labeled) on top of the exposed top surface thereof. Thus, even though the exposed top surface of the thermal storage medium 4′ or the bottom 511′ of the bottle 5′ is not perfectly flat, due to gravity, the thermal contact area 512′ of the Japanese-wine bottle 5′ can still have an effective contact with the thermal storage medium 4′. Thus, there will be no gap existed between the bottom 511′ of the Japanese-wine bottle 5′ and the thermal storage medium 4′, so that a better thermal conduction therebetween can be achieved.

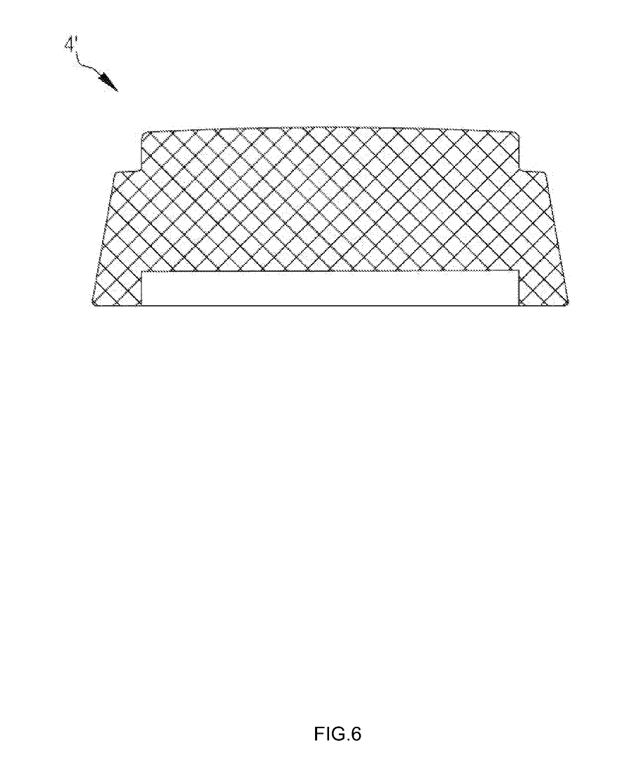

Due to the bottle 5′ having an insulating layer on its enclosing wall, even though the temperatures of the bottle 5′ and the wine contained therein are very high, the user does not feel uncomfortable upon touching the bottle 5′. Although this embodiment employs the Japanese-wine bottle 5′ as a container for the food heating kit 2′, those skilled in the art can replace the bottle 5′ with other forms of container, such as a pot, together with a dimension modification of the thermal storage pad if required. Irrespectively of the container's dimension or shape, the function of the food heating kit will not be influenced. Preferably, the thermal storage medium 4′ is shaped to have an upper projection and a lower recess corresponding to the upper projection, as shown in FIG. 6, so that multiple thermal storage mediums can be stacked up to facilitate storing or transporting them. As such, in a picnic, a user can carry multiple thermal storage mediums easily.

The food heating kit of the second exemplary embodiment employs the thermal storage medium to absorb electromagnetic waves produced by a microwave oven and then gradually release heat to food. However, there is a limitation in supplying heat to food; namely, when the thermal storage medium is not used for a length of time, the heat stored therein will be dissipated and thus it will finally lose the capability of heating foods. On the other hand, if multiple thermal storage pads are taken for spares, the convenience of operating the food heating kit will be reduced.

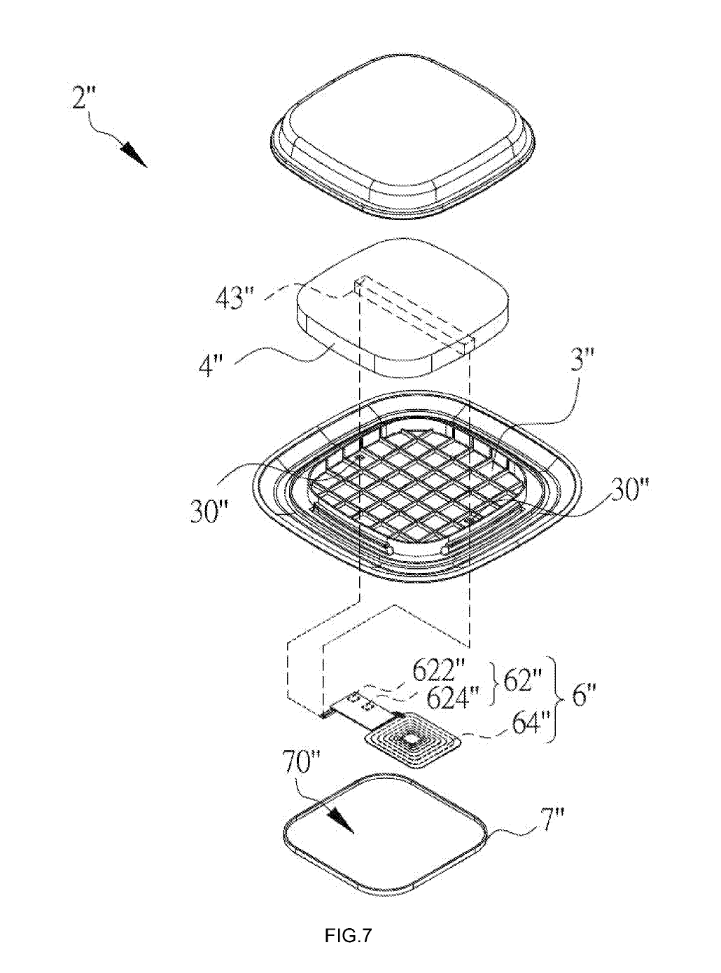

In view of the foregoing, as shown in FIG. 7, a third exemplary embodiment of the present invention is shown, wherein the microwave-heatable thermal storage pad 2″ of a food heating kit (now shown) is provided with a wireless charging module 6″ that receives electromagnetic waves of a specific frequency. As shown, The wireless charging module 6″ includes a control chip 62″ and a wireless receiving coil 64″ that receives electromagnetic waves emitted by a power transmitter (not shown). Furthermore, for preventing the heat stored in the thermal storage medium from directly acting on the control chip 62, which may cause damages to the chip, the wireless charging module 6″ is preferably located in the main body 3″ that has a lower thermal conductivity than the thermal storage medium 4″, so that the service life of the wireless charging module 6″ can be prolonged. As shown, two through holes 30″ are defined at the main body 3″, so that the wireless charging module 6″can employ two leads (not labeled) respectively passing through the two through holes 30″ to electrically connected with an electric heating module to form an electrical loop. In this embodiment, the electric heating module is a resistance wire 43. Of course, those skilled in the art may know that the resistance wire 43 can be replaced by other means, such as a carbon nanotube (CNT) heating film, without affecting the implementation of the wireless charging module.

According to the wireless charging standard of A4WP (Alliance for Wireless Power), a single power transmitter can transmit electromagnetic waves of a specific radio frequency to environment. Through inductive power transfer techniques, the wireless receiving coil of a charging device, such as the wireless charging module 6″, within a certain distance from the power transmitter can receive the electromagnetic waves of the specific radio frequency, so that the current can be produced in the receiving coil 64″ to flow along the electrical loop containing the resistance wire 43″, which allow the resistance wire 43″ to convert the electrical energy into thermal energy. Since the resistance wire 43 is located in contact with the thermal storage medium 4″, the thermal storage medium 4″ can obtain the thermal energy converted by the wire resistance 43″, so that the thermal storage pad 2″, which employs the wireless charging module 6″, can supply heat to a food at any time, thus facilitating a user to obtain a warm and palatable food.

Of course, those skilled in the art may know that the wireless charging module of this embodiment can also be achieved according to other standards, such as Power Matters Alliance (PMA) or Wireless Power Consortium (Qi), without affecting the implementation of the embodiment. Furthermore, the frequencies of the electromagnetic waves used in the wireless charging module of the present invention is not limited to the specified frequencies of those standards, as long as the frequencies meet the human body safety requirements under relevant specifications. Furthermore, the electric heating module can be disposed between the main body 3″ and the thermal storage medium 4″. For example, the electric heating module can be adhered to a bottom of the thermal storage medium 4″ to keep the medium warm through a thermal conductive adhesive.

Since the receiving coil 64″ of the wireless charging module 6″ is located within the effective transmission range of a power transmitter, it can continuously receive the electromagnetic waves emitted by the power transmitter to have the wire resistance 43″ generate heat for the thermal storage medium 4″. For preventing overheat of a food or boiling dry of a beverage contained in a container, the control chip 62″ used in the wireless charging module 6″ may include a temperature control unit 622″ and a temperature sensing unit 624″. Once the temperature sensing unit 622″ detects the temperature of the thermal storage medium 4″ exceeding a predetermined temperature (for example: 40 degrees C.), the temperature control unit 622″ can temporarily open the electrical loop to prevent current from being produced by the receiving coil 64″, so that the resistance wire 43″ cannot generate heat for the thermal storage medium 4″, so that thermal storage pad can maintain a desired temperature.

In the third exemplary embodiment, the microwave-heatable thermal storage pad 2″ may further include a non-slip bottom 7″, which can be joined to the main body 3″ and define a confined space 70″ between it and the main body 3″. The non-slip bottom 7″ can be joined to the main body 3″ by using engagement means, threaded bolts, or buttons. The wireless charging module 6″ can be entirely sealed in the confined space 70″, so that it can provide more accurate temperature control and facilitate the thermal storage pad 2″ to heat food. Of course, the wireless charging module 6″ can be installed at the holding flange of the main body 3″, wherein the receiving coil 64″ can be routed along a top surface of the holding flange of the main body 3″ and then be sealed by a sheet of silicone material. This way of installing a wireless charging module can also achieve the same function without affecting the implementation of the embodiment.

In the present invention, due to the holding flange of the main body having a lower thermal conductivity than the thermal storage medium fitted in the main body, after the thermal storage pad has been heated in a microwave oven, a use can directly take the holding flange of the main body without being scalded or burnt. Furthermore, in the food heating kit, since the engagement wall of the Japanese-wine bottle defines a shape corresponding to the projecting portion of the main body of the thermal storage pad, the thermal contact area of the Japanese-wine bottle can have a close contact with the thermal storage medium thereunder, thereby facilitating heat transfer between the bottle and the thermal storage medium, so that the heat stored in the thermal storage medium can be transferred substantially along the upward direction rather than other directions, so that the heat can be used more effectively, and thus the bottle can maintain a desired temperature for a longer time. Also, during a movement, the bottle can be prevented from falling away.

In the present invention, as illustrated in the third exemplary embodiment, a wireless charging module can replace a microwave oven for supplying thermal energy to a thermal storage medium, wherein the wireless charging module can receive the energy of electromagnetic waves emitted by a power transmitter, and then convert the received electromagnetic energy into corresponding heat for the thermal storage medium, which in turn transfers the heat to a food container, so that the heating time can be prolonged, and this allows the food to maintain a warm temperature for a long time. Furthermore, the wireless charging module can be arranged to isolate from the thermal storage medium, so that a failure of the control chip due to high temperature can be reduced. When the wireless charging module is fully sealed, water and dusts can also be blocked from interfering with the operation of the control chip, so that the control chip can be operated more properly, thus facilitating the operation of the thermal storage pad. As such, users can enjoy having warm and palatable foods at any time.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A microwave-heatable thermal storage pad, comprising:
a main body, which has at least one projecting portion and a holding flange extending outwardly from a peripheral edge of a bottom of the projecting portion, wherein the projecting portion has an enclosing wall of low thermal conductivity, the enclosing wall defining a recessed space that includes a top opening; and
at least one thermal storage medium located in the recessed space, the heat storage medium having an exposed top surface which is exposed to the top opening of the recessed space of the main body, and having a periphery which is at least partially surrounded by the enclosing wall of the projecting portion, wherein the thermal storage medium has a thermal conductivity greater than the enclosing wall of the projecting portion, whereby the thermal energy stored in the thermal storage medium will be exchanged with the outside substantially through the exposed top surface thereof.

2. The microwave-heatable thermal storage pad of claim 1, wherein the thermal storage medium further has a flexible thermal conductive layer on top of the exposed top surface thereof.

3. The microwave-heatable thermal storage pad of claim 1, wherein the thermal storage medium is a sintered ceramic body, which contains polar-substance powders and is fitted into the main body.

4. The microwave-heatable thermal storage pad of claim 1, wherein the main body has a non-slip bottom surface opposite to the exposed top surface of the thermal storage medium.

5. The microwave-heatable thermal storage pad of claim 1, further comprising a wireless charging module provided in the main body, and an electric heating module electrically connected with the wireless charging module and in thermal contact with the thermal storage medium.

6. The microwave-heatable thermal storage pad of claim 5, wherein the wireless charging module includes a wireless receiving coil, and the electric heating module includes at least one carbon nanotube heating film.

7. A food heating kit, comprising:
a microwave-heatable thermal storage pad, including
a main body, which has at least one projecting portion and a holding flange extending outwardly from a peripheral edge of a bottom of the projecting portion, wherein the projecting portion has an enclosing wall of low thermal conductivity, the enclosing wall defining a recessed space that includes a top opening; and
at least one thermal storage medium located in the recessed space, the heat storage medium having an exposed top surface which is exposed to the top opening of the recessed space of the main body, and having a periphery which is at least partially surrounded by the enclosing wall of the projecting portion, wherein the thermal storage medium has a thermal conductivity greater than the enclosing wall of the projecting portion, whereby the thermal energy stored in the thermal storage medium will be exchanged with the outside substantially through the exposed top surface thereof; and
a container, having:
a container shell having a bottom being provided with a thermal contact area;
an engagement wall extending downwardly from the bottom of the container shell; and
an enclosing wall extending upwardly from the bottom of the container shell to define a receiving space that includes a top opening.

8. The food heating kit of claim 7, wherein the container further has an insulating layer on an outer surface of the enclosing wall thereof, the insulating layer having a thermal conductivity lower than the thermal storage medium.

9. The food heating kit of claim 7, wherein the thermal storage medium further has a flexible thermal conductive layer on top of the exposed top surface thereof, and the main body has a non-slip bottom surface opposite to the exposed top surface of the thermal storage medium.

10. The food heating kit of claim 7, further comprising a wireless charging module provided in the main body, and an electric heating module electrically connected with the wireless charging module and in thermal contact with the thermal storage medium.
